(19) United States
(12) Patent Application Publication
(10) Pub. No.: US 2004/0239645 A1
(43) Pub. Date: Dec. 2, 2004

(54) Information processing apparatus and method of inputting character

(76) Inventor: Fujihito Numano, Hamura-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/765,136

(22) Filed: Jan. 28, 2004

(30) Foreign Application Priority Data
Jan. 29, 2003 (JP) 2003-020553

(51) Int. Cl. G09G 5/00

(52) U.S. Cl. 345/173; 345/156

(57) ABSTRACT

An information processing apparatus comprises a first input device capable of inputting character information, a second input device capable of inputting coordinates, and a handwritten character recognizing unit which recognizes character information based on the coordinates input by the second input device.

### CROSS-REFERENCE TO RELATED APPLICATIONS

This application is based upon and claims the benefit of priority from the prior Japanese Patent Application No. 2003-020553, filed Jan. 29, 2003, the entire contents of which are incorporated herein by reference.

### BACKGROUND OF THE INVENTION

1. Field of the Invention

The present invention relates to an information processing apparatus comprising an input device and a display device capable of performing a word processor function, and to a method of inputting a character.

2. Description of the Related Art

Portable personal computers of a notebook type or laptop type have recently been provided with a pointing device which enables, for example, a mouse pointing operation and a numeric key input operation (e.g., refer to Japanese Patent KOKAI Publication No. 2000-339097).

Here, an LCD is disposed behind a touch pad made of a transparent material. The touch pad is used as the pointing device to specify a position on an LCD screen, thereby inputting a trajectory of a point. The pointing device is used to input a movement trajectory of an index (pointer) which is displayed on the display screen of the LCD and moved in response to an input operation. The pointing device of this kind is capable of various screen operations, for example, movement control of a mouse pointer displayed on a display device and selection of a display button, by performing a pointing operation on a touch pad such as a touch movement operation and a tap operation.

On the other hand, in personal computers having a word processor function, document input is commonly achieved by keyboard operation. Under the present circumstances, document input can be most efficiently accomplished by the keyboard operation. For two-byte code characters as used in Japanese, the keyboard operation after all enables the most efficient document input by using a kana-kanji conversion function.

However, when a Chinese character, special character or the like that is not registered for kana-kanji conversion candidates is input from the keyboard, it is necessary to once stop a key operation so that a character code list is displayed on the display device, and then select a desired character with a mouse cursor or the like from the character code list, and this time-consuming input operation has been a problem.

As a method of inputting a character to solve this problem, such a method has been available wherein a handwriting recognition window in addition to a character input window is displayed on the display device, and a character desired to be input is input by hand through the pointing operation of the pointing device, and then character conversion is performed (e.g., “ATOK 13” issued on Sep. 8, 1999 by Justsystem Corporation (page 45)).

However, the method of inputting a character of this kind has a problem in terms of operability because it requires operations such as displaying the handwriting recognition window, changing windows for the mouse pointer, handwriting input and determining a recognition result, and handwriting character input is indirectly carried out by a pointing operation using the pointing device in the limited small handwriting recognition window.

Furthermore, in all of the input methods described above, it is necessary to once stop the keyboard operation every time a character is input by an operation other than the keyboard operation so as to operate the pointing device, and thus poor operability in character input has been a problem.

### BRIEF SUMMARY OF THE INVENTION

The present invention is directed to method and apparatus that substantially obviates one or more of the problems due to limitations and disadvantages of the related art.

According to an embodiment of the present invention, an information processing apparatus comprising:

a second input device capable of inputting coordinates representing character information;

an input character recognizing unit which recognizes the character information input by the first input device; and

a handwritten character recognizing unit which recognizes the character information represented by the coordinates input by the second input device.

According to another embodiment of the present invention, a method of inputting a character for a system comprising a main display device which displays a main operation screen, a sub display device capable of touch operation, and a keyboard which inputs a character by use of the main display device, the method comprising:

providing a handwritten character recognizing unit in the sub display device;

displaying document information input by an operation of the keyboard on the main display device; and

displaying on the sub display device candidate characters recognized by the handwritten character recognizing unit in accordance with an input operation trajectory by the sub display device.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a perspective view showing an external configuration of an information processing apparatus according to an embodiment of the present invention;

FIG. 2 is a block diagram showing a system configuration of the information processing apparatus;

FIG. 3 is a diagram showing functional components of a sub display device in the information processing apparatus;

FIG. 4 is a diagram explaining an operation for document creation processing in the information processing apparatus;

FIG. 5 is a flowchart showing a processing procedure of a handwritten character recognition processing program in the document creation processing;

FIGS. 6A, 6B and 6C are views showing operation screen transitions and operation examples thereof in the handwritten character recognition processing; and

FIG. 7 is a view showing a display example of the operation screen in the handwritten character recognition processing in another embodiment.

### DETAILED DESCRIPTION OF THE INVENTION

An embodiment of an information processing apparatus according to the present invention will now be described with reference to the accompanying drawings.

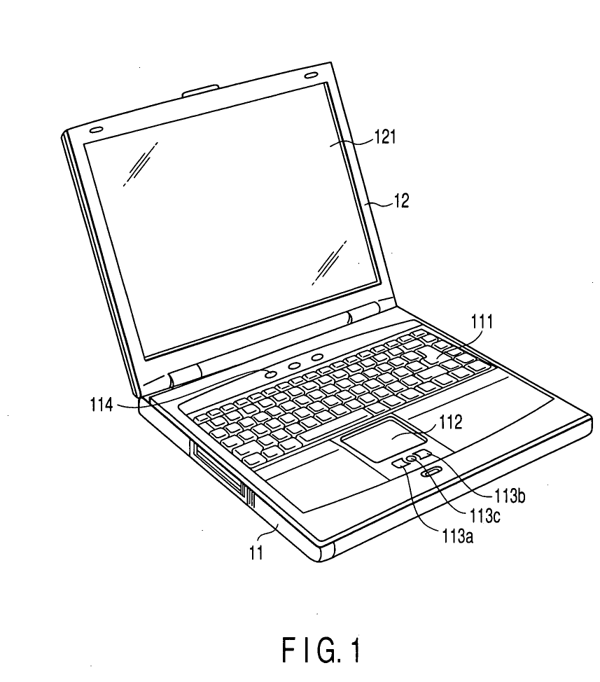

FIG. 1 is a perspective view showing an external configuration of an information processing apparatus according to an embodiment of the present invention. A notebook-type personal computer is shown here as an example.

The notebook-type personal computer comprises a computer main body 11 and a display unit 12. A main display device 121 including an LCD is built into the display unit 12. The display unit 12 is attached to the computer main body 11 rotatably between an open position and a closed position. The computer main body 11 has a thin box-shaped case, and on an upper surface of the case, a power button 114 for turning on/off a power supply of the computer main body 11, a keyboard 111 and the like are disposed. An armrest is formed on the upper surface of the case portion before the keyboard 111. In an almost central portion of the armrest, a sub display device (touch pad device) 112 having a touch screen function is provided. The sub display device 112 forms a display-integrated type pointing device which is integrally provided with a display panel, such as the LCD having a display screen size smaller than that of the main display device 121, and a tablet, and this sub display device 112 is disposed on the upper surface of the case forming the armrest, together with a left button 113a, a right button 113b and a middle button 113c. The tablet is made of a transparent material, and the display panel is provided at the back of the tablet.

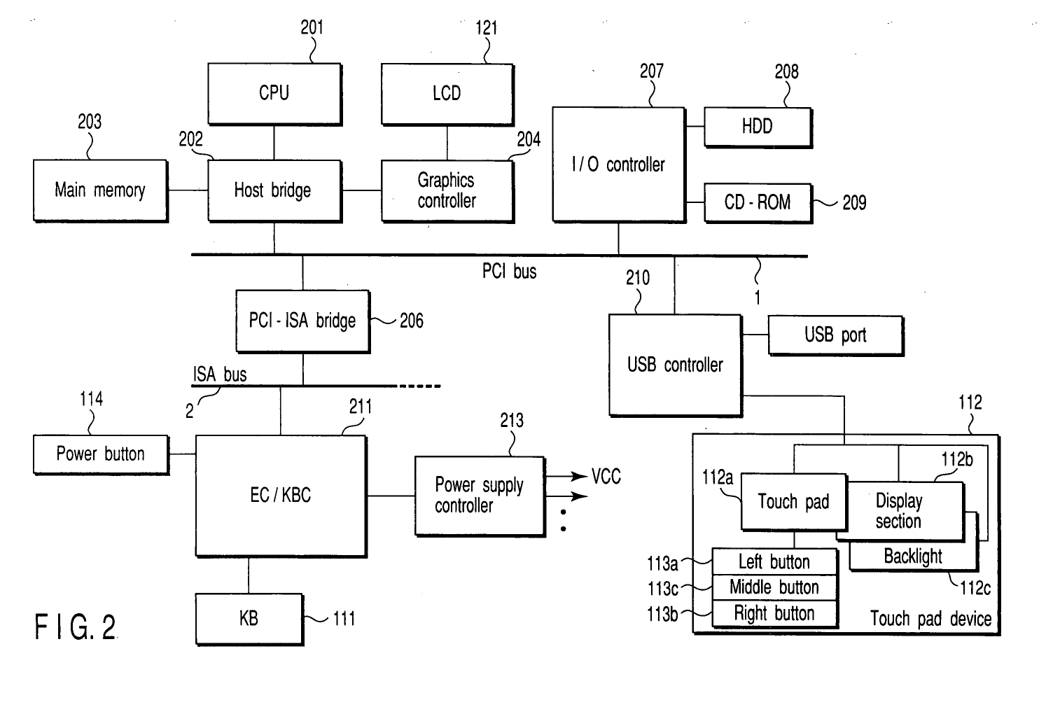

FIG. 2 is a block diagram showing a system configuration of the computer shown in FIG. 1. The present system comprises a CPU 201, a host bridge 202, a main memory 203, a graphics controller 204, a PCI-ISA bridge 206, an I/O controller 207, a hard disk drive (HDD) 208, a CD-ROM drive 209, a USB controller 210, an embedded controller/keyboard controller IC (EC/KBC) 211, a power supply controller 213 and the like.

The sub display device 112 mentioned above is connected to the USB controller 210. The sub display device 112 integrates a touch pad 112a, a display section 112b and a backlight 112c to enable a touch screen function, and includes the left button 113a, the right button 113b and the middle button 113c.

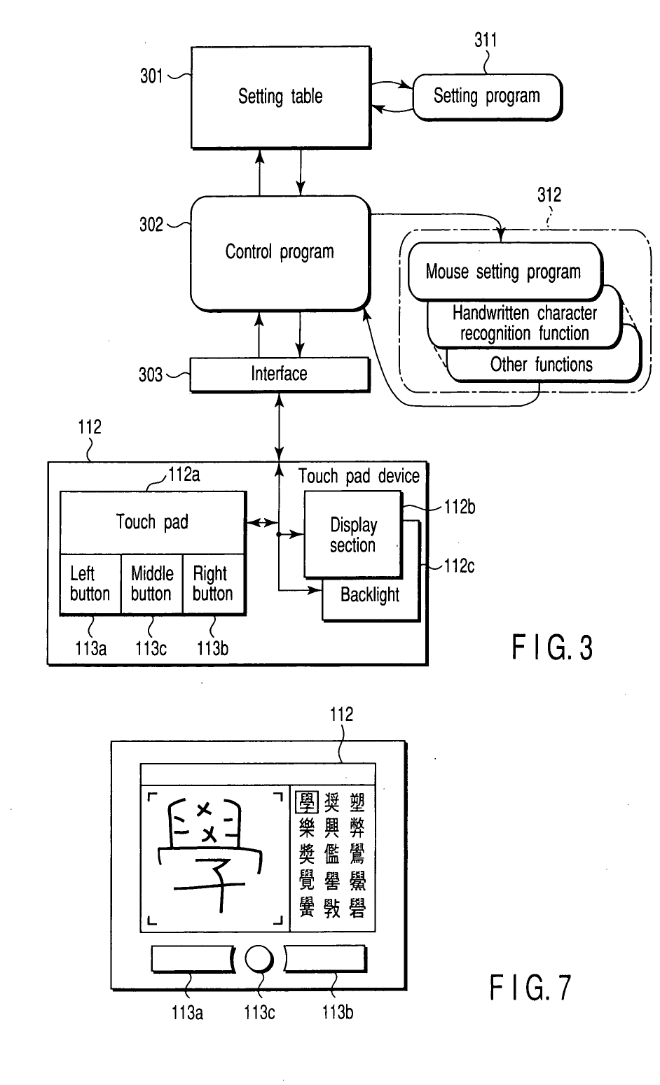

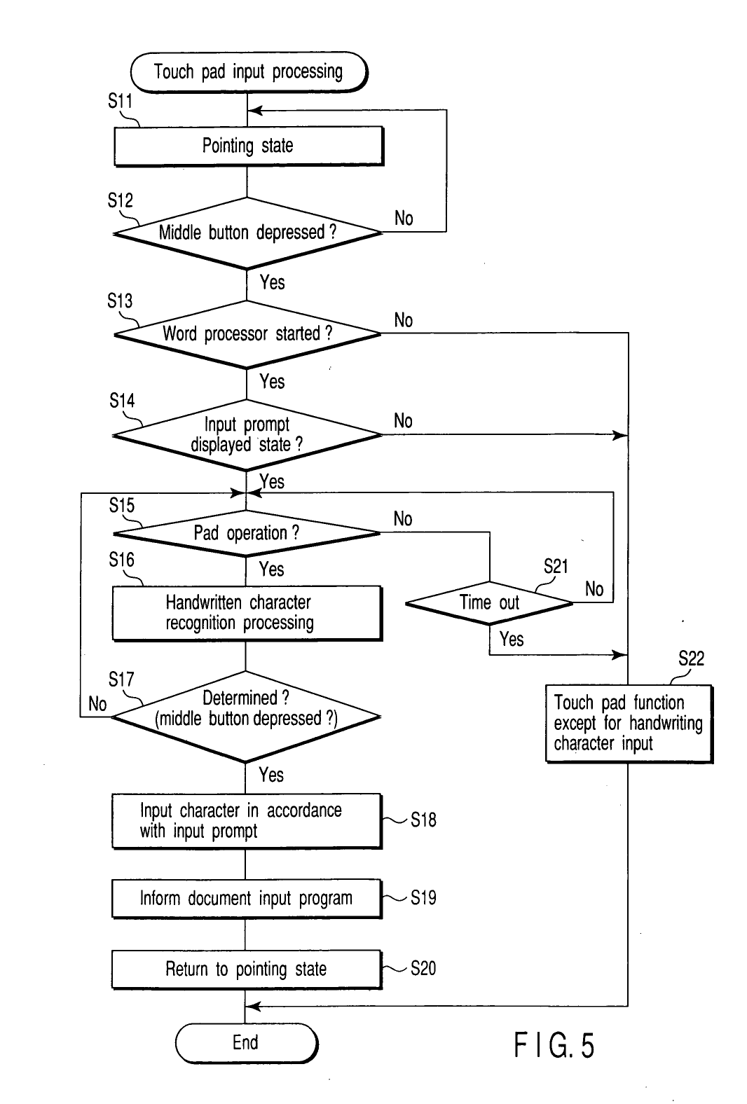

The CPU 201 controls an operation of the present embodiment, and executes an operating system (OS) loaded into the main memory 203 from the hard disk drive (HDD) 208, application programs, utility programs and the like. In this embodiment, the CPU 201 executes processing of a control program (see FIG. 3) for the sub display device 112 and processing of an input-output program to enable a positioning processing function of a mouse pointer through one-touch operation on the sub display device 112 shown in FIG. 5 described later in collaboration with a mouse driver.

The host bridge 202 is a bride device which bi-directionally connects a local bus of the CPU 201 and a PCI bus 1. The graphics controller 204 comprises a video RAM (VRAM), and controls the main display device 121 used as a display monitor of the present embodiment under the control of a dedicated display driver. The I/O controller 207 controls the hard disk drive (HDD) 208, the CD-ROM drive 209 and the like. The PCI-ISA bridge 206 is a bridge device which bi-directionally connects the PCI bus 1 and an ISA bus 2, and various kinds of system devices such as a system timer, a DMA controller and an interrupt controller are built therein.

The embedded controller/keyboard controller IC (EC/KBC) 211 is a one-chip microcomputer in which an embedded controller (EC) for power management and a keyboard controller (KBC) for controlling the keyboard 111 are integrated. The embedded controller/keyboard controller IC (EC/KBC) 211 has a function to power on/off the present embodiment in accordance with an operation of the power button 114 by a user in collaboration with the power supply controller 213.

FIG. 3 is a diagram showing functional components of the sub display device 112 in the embodiment of the present invention, and the components here include a setting table 301 which sets a function of the sub display device 112; a control program 302 which controls the function of the sub display device 112 in accordance with contents of the setting table 301; an interface 303 which controls input and output of information exchanged between the sub display device 112 and the control program 302; a setting program 311 which creates the setting table 301 by use of a GUI; execution means 312 for executing various kinds of processing in accordance with instructions from the control program 302; and the sub display device 112.

In the embodiment, the execution section 312 switches the function of the sub display device 112 between a pointing function which follows control of a mouse setting program and a handwritten character recognition function which follows a handwritten character recognition processing program, in accordance with an operation of the middle button 113c (see FIG. 5).

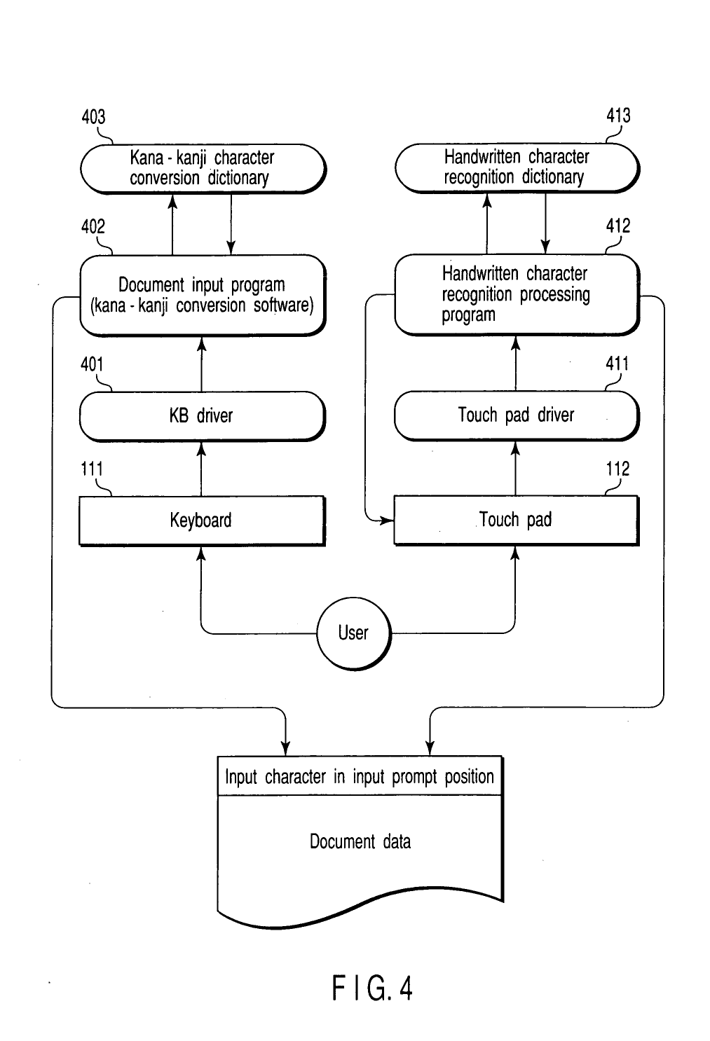

FIG. 4 is a diagram explaining an operation for document creation processing in the embodiment of the present invention. Here, it shows processing in which a character input by a key operation on the keyboard 111 and kana-kanji-converted, and a character which is input by a figure touch operation on the sub display device 112 and on which handwritten character recognition is performed by following an operation trajectory are input into a created document in accordance with an input prompt of this created document displayed on the main display device 121.

The CPU 201 executes processing of a document input program (kana-kanji conversion software) 402 stored in the main memory 203 so as to accomplish input processing of the kana-kanji-converted character input by the key operation on the keyboard 111. The CPU 201 executes processing of a handwritten character recognition processing program 412 stored in the main memory 203 so as to accomplish input processing of the character input by the figure touch operation on the sub display device 112 and on which handwritten character recognition is performed.

When a document is created in an ordinary keyboard operation, the document input program (kana-kanji conversion software) 402 is started up, and key input data input from the keyboard 111 is supplied to the document input program 402 via a keyboard driver 401. The document input program 402 subjects the key input data to kana-kanji conversion processing by use of a kana-kanji character conversion dictionary 403, and inputs the kana-kanji-converted character into the created document in accordance with the input prompt of this created document displayed on the main display device 121.

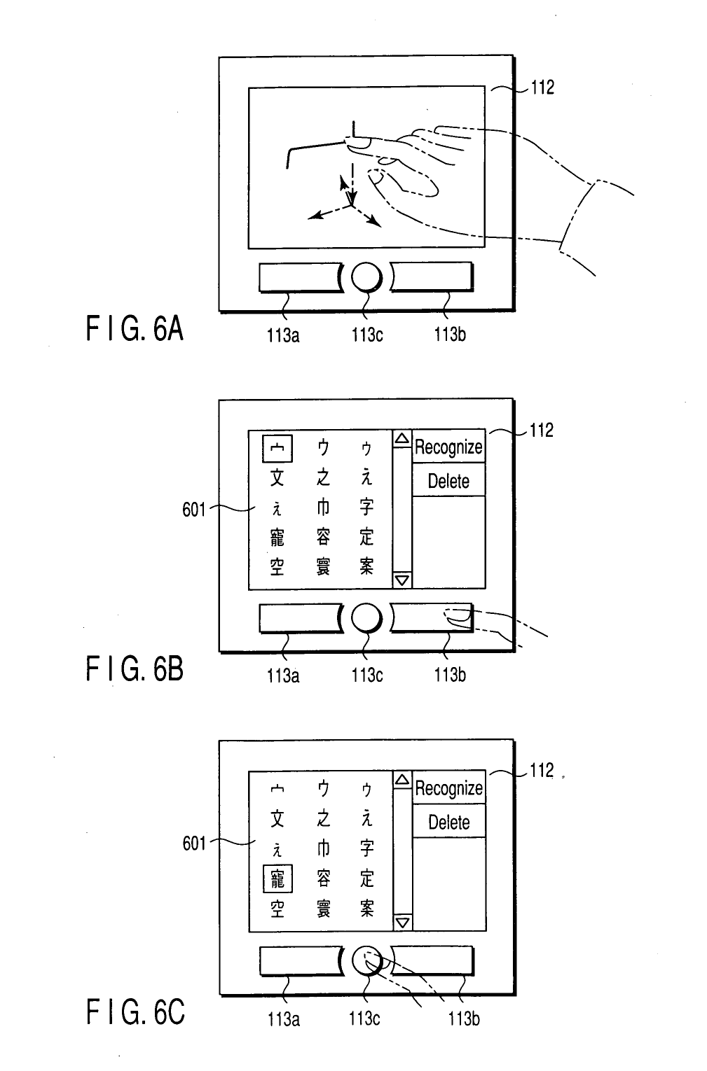

When a user inputs a character by use of handwritten character recognition on the sub display device 112 instead of the keyboard operation, the user depresses the middle button 113c. The depressing of the middle button 113c starts up the handwritten character recognition processing program 412 in place of the document input program 402, and data on the operation trajectory input by the finger touch operation on the sub display device 112 is supplied to the handwritten character recognition processing program 412 via a driver (touch pad driver) 411 of the sub display device 112. The handwritten character recognition processing program 412 obtains candidate characters from a handwritten character recognition dictionary 413 in accordance with the operation trajectory input as shown in FIG. 6A, and displays the obtained candidate characters in a character selection window in such a display form as shown in FIG. 6B on the sub display device 112. When one character is selected, for example, by the touch operation on the character selection window (FIG. 6C), the handwritten character recognition processing program 412 regards the selected candidate character as a determined character and inputs it into the created document in accordance with the input prompt of this created document displayed on the main display device 121. In this way, the handwritten character obtained from the operation trajectory on the sub display device 112 is input into the input document while being treated in the same manner as the kana-kanji-converted character input by the key operation.

FIG. 5 is a flowchart showing a processing procedure of the handwritten character recognition processing program 412 in the embodiment, and the CPU 201 achieves the processing of the handwritten character recognition processing program 412 stored in the main memory 203. Here, the function of the sub display device 112 is switched (switched between the pointing function which follows the control of the mouse setting program and the handwritten character recognition function which follows the handwritten character recognition processing program) by the operation of the middle button 113c, but this function can also be switched by other key or button operations, for example, an operation of a specific key of the keyboard 111 and an operation of a specific tap on the sub display device 112.

FIGS. 6A, 6B and 6C are views showing operation screen transitions and operation examples thereof in handwriting character input in the embodiment. As one example, an operation to switch the candidate characters on a character selection window 601 is performed with the right button 113b and an operation to select (enter) a character is performed with the middle button 113c, but a desired candidate character can also be directly selected by touching on the character selection window 601 with a finger.

A handwritten character recognition processing operation in the embodiment of the present invention will here be described in reference to the drawings.

When a word processor is started up (when document creation is started), the CPU 201 starts the document input program (kana-kanji conversion software) 402, and executes processing in accordance with this program to subject the key input data input by the key operation on the keyboard 111 to the kana-kanji conversion by use of the kana-kanji conversion dictionary 403, and then inputs the kana-kanji-converted character in an input prompt position of the created document displayed on the main display device 121 by way of a predetermined determination section (see FIG. 4).

When a character is input by use of the kana-kanji conversion through the key input operation on the keyboard 111, the sub display device 112 is in a state of the pointing function capable of the pointing operation in accordance with the control of the mouse setting program (step S11 of FIG. 5).

When inputting a character by use of the kana-kanji conversion through the key input operation on the keyboard 111, if the user operates the middle button 113c instead of operating on the keyboard as an extended operation of the keyboard operation, the CPU 201 starts the handwritten character recognition processing program 412 in place of the document input program (kana-kanji conversion software) 402 (step S12 of FIG. 5). In this processing, it is confirmed that the word processor is started (Yes in step S13 of FIG. 5) and that an input program for inputting documents is in a state displayed on the main display device 121 (Yes in step S14 of FIG. 5), before moving to the handwritten character recognition processing.

In the handwritten character recognition processing, the operation trajectory on the sub display device 112 is sequentially recognized, and the candidate characters are obtained from the handwritten character recognition dictionary 413 on the basis of the operation trajectory, and thus the character selection window 601 is displayed on the sub display device 112 in such a display form as shown in FIG. 6B in accordance with the candidate characters (steps S15 and S16 of FIG. 5).

Furthermore, in the handwritten character recognition processing, when a desired candidate character is selected, for example, by the finger touch operation shown in FIG. 6C on the character selection window 601 (Yes in step S17 of FIG. 5), the selected candidate character is regarded as a character determined by the handwriting character input and is input into the input prompt position of the created document displayed on the main display device 121 (step S18 of FIG. 5), and the function of the sub display device 112 is switched from the handwritten character recognition function which follows the handwritten character recognition processing program 412 to the pointing function which follows the control of the mouse setting program (steps S19 and S20 of FIG. 5).

In addition, if the input by the operation trajectory on the sub display device 112 is stopped within a range that does not exceed a preset time (e.g., 2 seconds), the character selection window 601 of the candidate characters in accordance with the input operation trajectory is displayed during this period (No in step S21 of FIG. 5), but if the operation trajectory is not input even after the set time has passed (Yes in step S21 of FIG. 5), the function of the sub display device 112 is switched to other functions or the pointing function (See FIG. 3; step S22 of FIG. 5).

In this way, character input can be changed from the kana-kanji conversion input by the keyboard operation to the handwriting character input by the touch operation on the sub display device 112 as the extension of the keyboard operation with little change in a hand position, thereby making it possible to efficiently and quickly perform the handwriting character input as compared with the input operation that requires to change to an operation device such as a mouse or pen.

According to the embodiment of the present invention, there are provided an information processing apparatus and a method of inputting a character which enable efficient character input in an operation other than a keyboard operation.

FIG. 7 is a view showing a display example of the operation screen for the handwriting character input in another embodiment of the present invention. For the handwritten character recognition dictionary 413, the same dictionary as the dictionary for the kana-kanji conversion in the key input operation is used in the embodiment described above. In a configuration of the embodiment shown in FIG. 7, however, only characters or character types that are not handled in the kana-kanji conversion, or predetermined characters or character types (e.g., those limited in accordance with application) are registered on the handwritten character recognition dictionary 413, and in the handwritten character recognition processing, the candidate characters are displayed in a selectable manner within a small range of characters or character types registered on the handwritten character recognition dictionary 413 in accordance with the operation trajectory on the sub display device 112.

With such a configuration that limits the candidate characters for the handwritten character recognition, an operation to select the candidate characters can be efficiently performed, and the handwritten character recognition function can be more easily used. Further, the characters or character types are separated respectively for the character input performed by the keyboard operation using the kana-kanji conversion and for the handwriting character input performed on the sub display device 112 using the handwritten character recognition, thereby making it possible to improve operability in the character input.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An information processing apparatus comprising:
a first input device capable of inputting character information;
a second input device capable of inputting coordinates representing character information;
an input character recognizing unit which recognizes the character information input by the first input device; and
a handwritten character recognizing unit which recognizes the character information represented by the coordinates input by the second input device.

2. The apparatus according to claim 1, further comprising:
a first display device which displays the character information input by the first input device;
a second display device which displays a trajectory of the coordinates input by the second input device; and
a controller which displays the character information which is recognized by the handwritten character recognizing unit on one of the first display device and the second display device.

3. The apparatus according to claim 2, wherein the handwritten character recognizing unit obtains candidate characters based on the trajectory of the coordinates input by the second input device; and
the controller displays the candidate characters obtained by the handwritten character recognizing unit on the second display device.

4. The apparatus according to claim 3, wherein the controller displays a character selection window in which the candidate characters are arranged in character units in a selectable manner on the second display device.

5. The apparatus according to claim 4, wherein
the handwritten character recognizing unit which recognizes character information based on the coordinates input by the second input device for a character which can not be input by the first input device.

6. The apparatus according to claim 4, wherein
the handwritten character recognizing unit which recognizes character information based on the coordinates input by the second input device for a character above a certain level which requires a candidate selection operation.

7. The apparatus according to claim 4, wherein
the handwritten character recognizing unit which recognizes character information based on the coordinates input by the second input device for a predetermined character or character type.

8. The apparatus according to claim 4, wherein when one of the candidate characters is selected from the character selection window displayed on the second display device in a state where an input prompt of an input document is displayed on the first display device, the controller displays, as a determined character, the selected candidate character in a character input position which is indicated by the input prompt of the input document displayed on the first display device.

9. The apparatus according to claim 4, wherein the second input device and the second display device are formed by a pointing device having a touch screen which is integrally provided with a tablet and a display panel.

10. The apparatus according to claim 9, wherein the controller switches between a pointing operation mode and a handwritten character recognition mode in accordance with a touch operation signal of the pointing device.

11. The apparatus according to claim 9, wherein the controller selects one of the candidate characters and determines the character to be input, in accordance with the touch operation signal of the pointing device.

12. The apparatus according to claim 9, wherein
the pointing device comprises an operation button; and
the controller switches between the pointing operation mode and the handwritten character recognition mode in accordance with an operation signal of the operation button.

13. The apparatus according to claim 12, wherein the controller selects one of the candidate characters and determines the character to be input, in accordance with the operation signal of the operation button.

14. A method of inputting a character for a system comprising a main display device which displays a main operation screen, a sub display device capable of touch operation, and a keyboard which inputs a character by use of the main display device, the method comprising:
providing a handwritten character recognizing unit in the sub display device;
displaying document information input by an operation of the keyboard on the main display device; and
displaying on the sub display device candidate characters recognized by the handwritten character recognizing unit in accordance with an input operation trajectory by the sub display device.

15. The method according to claim 14, further comprising:
displaying each of the candidate characters recognized by the handwritten character recognizing unit on the sub display device in a selectable manner by a touch operation.

16. The method according to claim 15, further comprising:
determining the candidate character selected by the touch operation as the input character; and
inputting the determined character in a character input position of a document which is input by a keyboard operation and displayed on the main display device.

17. The method according to claim 14, further comprising:
providing operation buttons in the sub display device; and
switching between a pointing operation mode and a handwritten character recognition mode by operating the operation button.

18. The method according to claim 14, further comprising:
displaying character input buttons selectable by the touch operation on the sub display device, which are intended for predetermined certain characters or character types.
